(19) United States
(12) Patent Application Publication
(10) Pub. No.: US 2012/0325510 A1
(43) Pub. Date: Dec. 27, 2012

(54) IMPACT WRENCH WITH IMPROVED REDIRECTION SWITCH

(75) Inventors: YUNG-YUNG SUN, TAICHUNG CITY 412 (TW); CHUAN-CHING CHENG, TAICHUNG CITY 406 (TW)

(73) Assignee: STORM PNEUMATIC TOOL CO., LTD., TAICHUNG CITY (TW)

(21) Appl. No.: 13/164,837

(22) Filed: Jun. 21, 2011

(51) Int. Cl. B25D 11/00

(52) U.S. Cl. 173/91

(57) ABSTRACT

An impact wrench with an improved redirection switch includes a housing, a motor shell, an on/off bar set, and a redirection switch. The pushing bar of the redirection switch and the redirection valve are connected in tandem along the same horizontal line. The rotational axis of the rotating redirection valve is perpendicular to the penetrating axis of the on/off bar set, instead of the same penetrating axis line. Therefore, the invention achieves the redirection effect without increasing the volume of its handle.

### BACKGROUND OF THE INVENTION

1. Field of Invention

The invention relates to the structure of an impact wrench and, in particular, to an impact wrench with an improved redirection switch.

2. Related Art

The redirection structure of a conventional impact wrench is shown in FIGS. 8 and 9. The top part of its handle 7 is penetrated with a control bar 71. An air intake valve 72 is pivotally mounted on the control bar 71 and accommodated in an air valve sleeve 73. The air valve sleeve 73 has a forward hole 731 and a reverse air hole 732. The air intake valve 72 has a forward air intake hole 721 and a reverse air intake hole 722 corresponding to the forward and reverse holes 731, 732 of the air valve sleeve 73. The air intake valve 72 is driven by a switching bar 74 to rotate with respect to the air valve sleeve 73. When the air intake valve 72 rotates to a position so that the forward air intake hole 721 thereof and the forward hole 731 of the air valve sleeve 73 are connected, the impact wrench is driven to rotate forward. When the air intake valve 72 rotates to a position so that the reverse air intake hole 722 thereof and the reverse hole 732 of the air valve sleeve 73 are connected, the impact wrench is driven to rotate in reverse. Nevertheless, the above-mentioned redirection structure has the following problems.

Since the air intake valve 72 has a fixed length and is mounted coaxially on the control bar 71 and the switching bar 74 is connected to the front end of the air intake valve 72, it is likely to be unsmooth for the switching bar 74 to drive the air intake valve 71.

Moreover, the switching bar 74 is located at the front end of the top part of the handle. Therefore, when a user holds the handle, it becomes inconvenient for the user to operate as the switching bar is in the front portion.

Besides, the redirection structure is disposed inside the handle 7. The volume of the handle 7 is thus enlarged. The cross sections of the air intake and exhaust passages 74, 75 inside the handle 7 are blocked. This reduces the output torque of the impact wrench.

### SUMMARY OF THE INVENTION

One objective of the invention is to provide an impact wrench with an improved redirection switch that functions smoothly and is easy to operate.

Another objective of the invention is to provide an impact wrench with an improved redirection switch, so that the cross sections of the air intake and exhaust passages of the impact wrench are not directly affected by the redirection valve.

To achieve the above-mentioned objectives, the disclosed impact wrench includes: a housing, a motor shell, an on/off bar set, and a redirection switch.

The housing has an accommodating space. The lower part of the housing is extended with a handle with an air intake passage. The motor shell is disposed in the accommodating space of the housing. The bottom of the motor shell has an accommodating recess. One side of the inner wall of the accommodating recess is connected to a forward intake passage and a reverse intake passage. The bottom of the motor shell is further formed with a switching recess that is connected with the other side of the inner wall of the accommodating recess and is through both sides of the motor shell. The on/off bar set is disposed below the motor shell. The on/off bar set controls the on/off of the intake passage of the handle for air to enter the motor shell via the accommodating recess.

The redirection switch includes a switching valve disposed in the accommodating recess of the motor shell and a pushing bar disposed in the switching recess of the motor shell and exposed from two opposite sides of the housing. The pushing bar and the redirection valve are connected in tandem along a horizontal line. The redirection valve is driven to rotate in the accommodating recess. The rotational axis direction of the redirection valve is perpendicular to the penetrating axis of the on/off bar set. The bottom of the redirection valve has an air intake hole corresponding to the air intake passage of the handle. The end surface of the redirection valve other than the one connected to the pushing bar has a connecting hole in communication with the air intake hole. The connecting hole is connected with the forward intake passage or the reverse intake passage when the pushing bar rotates the redirection valve.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a three-dimensional exploded view of the invention;

FIG. 2 is a three-dimensional view of the disclosed redirection valve;

FIG. 3 is a three-dimensional view of the invention after assembly;

FIG. 4 is a local cross-sectional view of the invention after assembly;

FIG. 5 is a cross-sectional view of the invention after assembly;

FIG. 6 is a schematic view of the invention in use, showing that the impact wrench is in the forward mode;

FIG. 7 is another schematic view of the invention in use, showing that the impact wrench is in the reverse mode;

FIG. 8 is an exploded view of the redirection structure in a conventional impact wrench; and

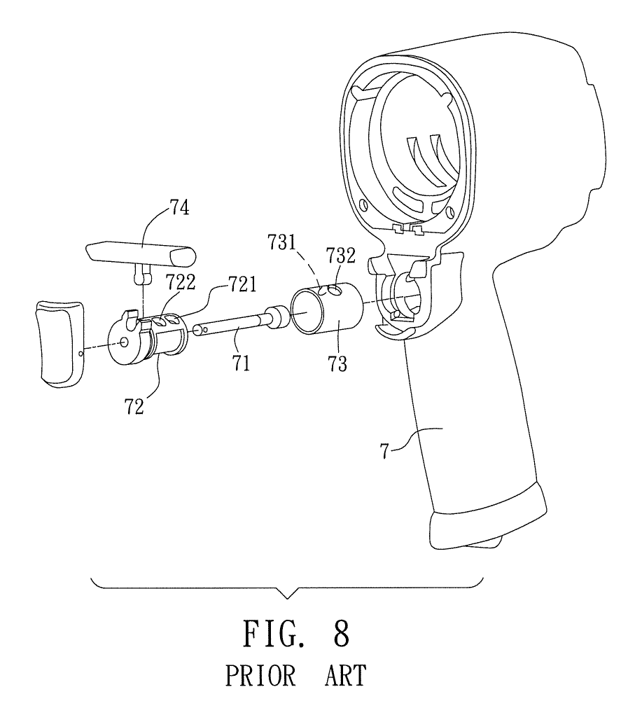

FIG. 9 is a cross-sectional view of the redirection structure in a conventional impact wrench.

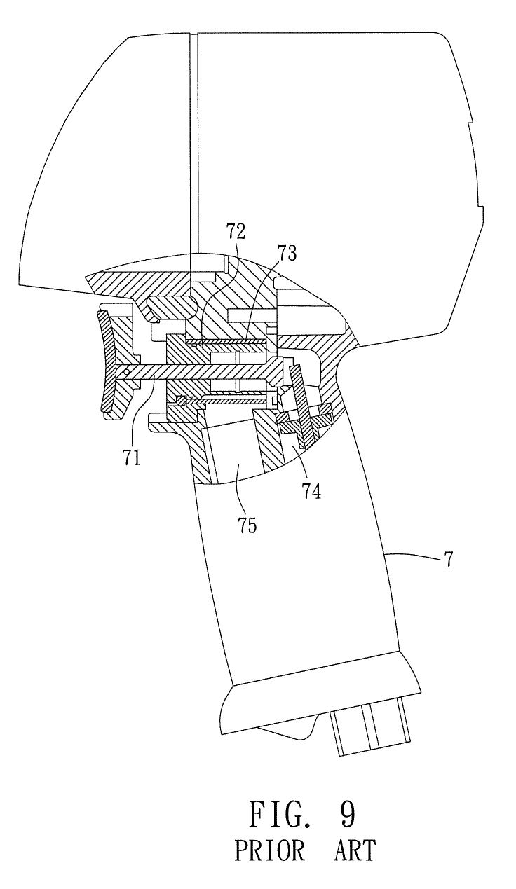

### DETAILED DESCRIPTION OF THE INVENTION

The present invention will be apparent from the following detailed description, which proceeds with reference to the accompanying drawings, wherein the same references relate to the same elements.

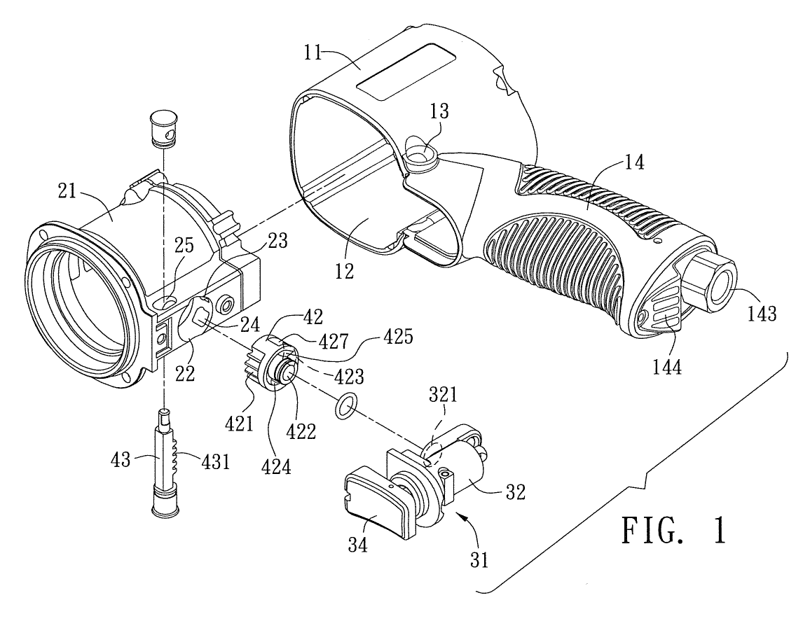

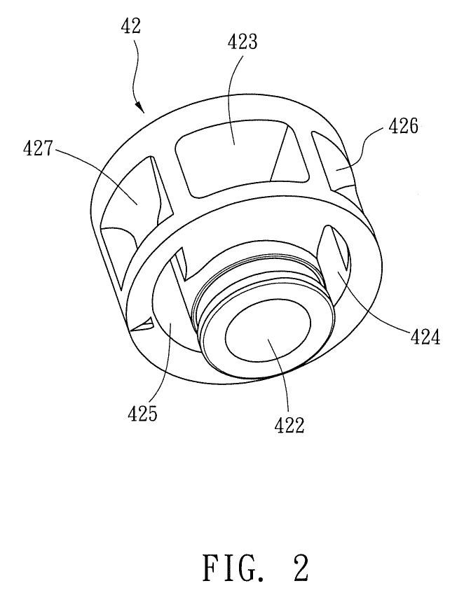

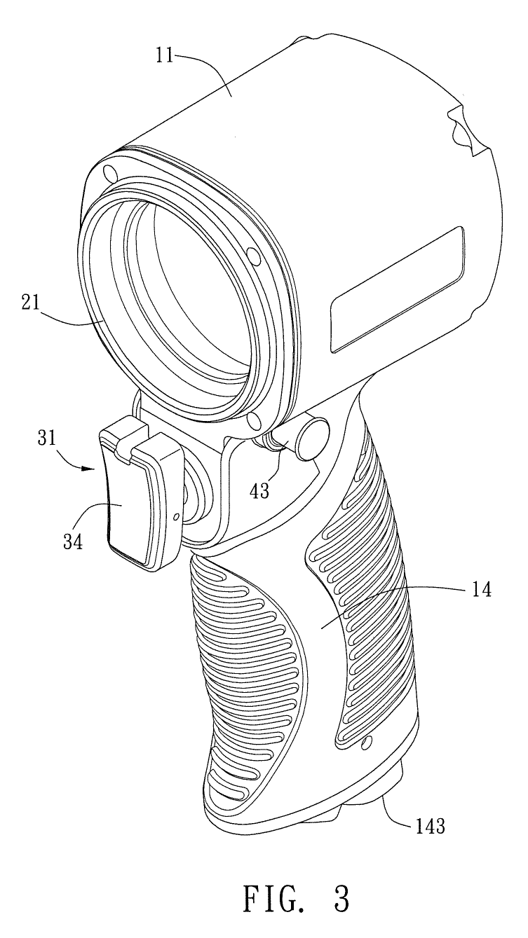

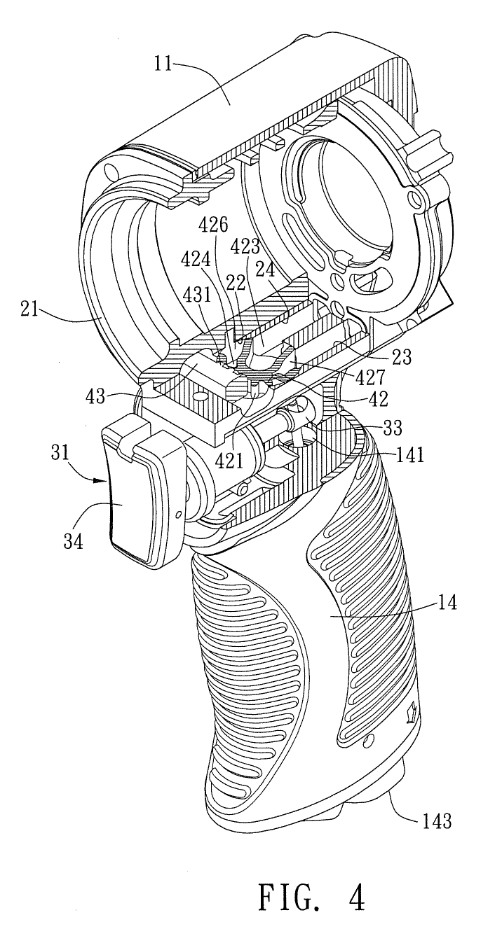

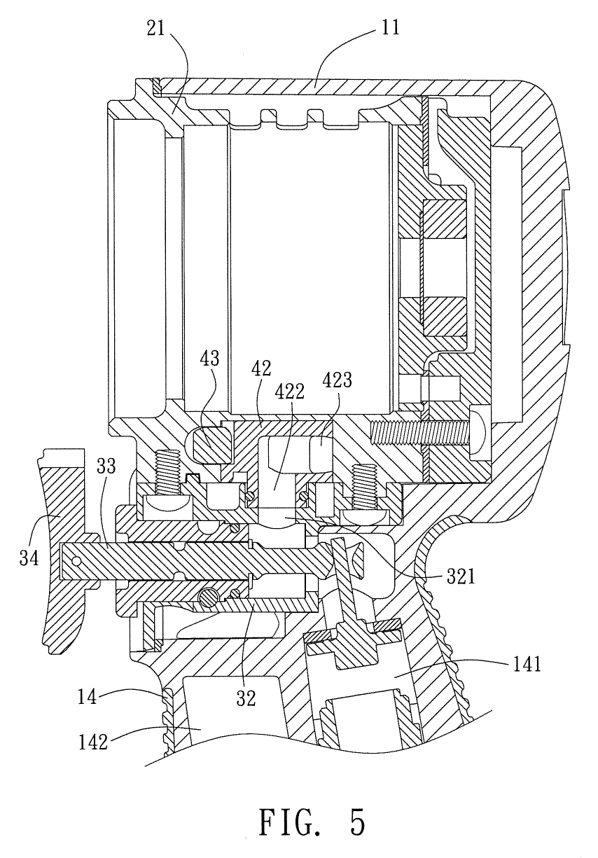

Please refer to FIGS. 1 to 5. The invention mainly consists of a housing 11, a motor shell 21, an on/off bar set 31, and a redirection switch 41.

The interior of the housing 11 has an accommodating space 12 and a through hole 13 penetrating through two opposite sides of the housing 11. The housing 11 has a handle 14 with an air intake passage 141 and an air exhaust passage 142. The air intake passage 141 has a connecting part 143 exposed from the bottom part of the handle 14 for connecting to a high-pressure air pipeline. The air exhaust passage 142 has several exhaust holes 144 at the bottom of the handle 14.

The motor shell 21 is disposed in the accommodating space 12 of the housing 11. The motor shell 21 is installed with a motor (not shown). The bottom part of the motor shell 21 has an accommodating recess 22. One side of the inner wall of the accommodating recess 22 is connected with a forward air intake passage 23 and a reverse air intake passage 24. The forward air intake passage 23 and the reverse air intake passage 24 are connected to the motor, respectively. When air enters via the forward air intake passage 23, the motor is driven to rotate forward. On the other hand, when air enters via the reverse air intake passage 24, the motor is driven to rotate in reverse. At the bottom of the motor shell 21, a switching recess 25 is formed in the direction perpendicular to the axis of the accommodating recess 22 and in communications with the other side of the inner wall of the accommodating recess 22, across both sides of the motor shell 21.

The on/off bar set 31 is disposed at the top of the handle 14 and under the motor shell 21. The on/off bar set 31 has an action bar 33 in a fixing base 32. The fixing base 32 is disposed at the bottom of the motor shell 21 and has an opening 321 opposite to the accommodating recess 22. The end of the action bar 33 toward the interior of the handle 14 controls the air intake passage 141. The other end thereof toward the exterior of the handle 14 is connected to a trigger 34. Pressing the trigger 34 moves the action bar 33, thereby allowing or disallowing air through the air intake passage 141 of the handle 14 to enter the motor shell 21 via the opening 321.

The redirection switch 41 includes a redirection valve 42 disposed in the accommodating recess 22 of the motor shell 21 and a pushing bar 43 disposed in the switching recess 25 of the motor shell 21 and exposed from opposite sides of the housing 11 from the through hole 13 thereof. It should be noted that the pushing bar 43 and the redirection valve 42 are connected in tandem along a horizontal line. In this embodiment, the end surface of the pushing bar 43 connecting to the redirection valve 42 has a continuous row tooth part 431. The end surface of the redirection valve 42 connecting to the pushing bar 43 has a snap tooth part 421 that matches with the row tooth part 431. Moving the pushing bar 43 drives the redirection valve 42 to rotate in the accommodating recess 22. The extension direction of the rotational axis of the redirection valve 42 is perpendicular to the penetrating axis of the on/off bar set 31. The bottom of the redirection valve 42 has an air intake hole 422 corresponding to the air intake passage 141 of the handle 14. The end surface of the redirection valve 42 other than that connected to the pushing bar 43 has a connecting hole 423 in communications with the air intake hole 422. As the pushing bar 43 drives the redirection valve 42 to rotate, the connecting hole 423 is connected to the forward air intake passage 23 or the reverse air intake passage 24. A through hole 426, 427 is formed on both sides of the connecting hole 423, respectively. Two exhaust holes 424, 425 are formed by the air intake hole 422 of the redirection valve 42. The two exhaust holes 424, 425 are in communications with the exhaust passage 142 of the handle 14 for releasing air. Moreover, the two exhaust holes 424, 425 extend to go through the through holes 426, 427 on both sides of the connecting hole 423. When the connecting hole 423 of the redirection valve 42 is in communications with the forward air intake passage 23, the through hole 426 of one exhaust hole 424 is in communications with the reverse air intake passage 24. When the connecting hole 423 of the redirection valve 42 is in communications with the reverse air intake passage 24, the through hole 427 of the other exhaust hole 425 is in communications with the forward air intake passage 23.

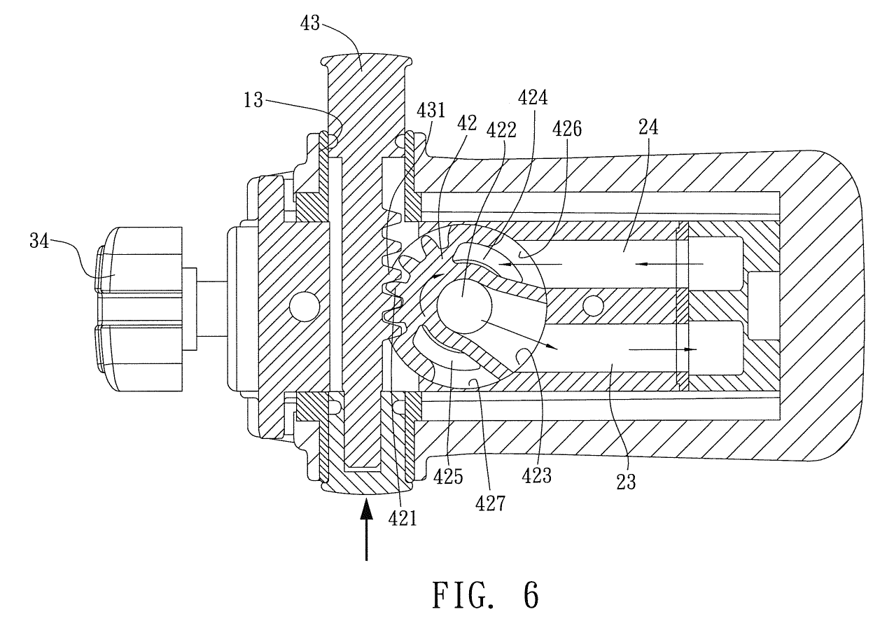

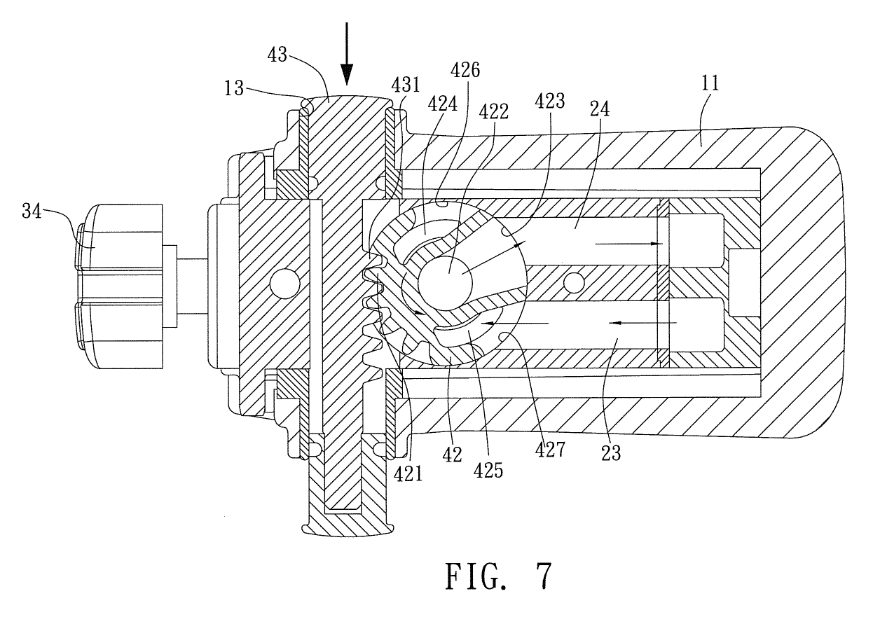

As shown in FIG. 6, during its operation, its user pushes the pushing bar 43 of the redirection switch 41 to rotate the redirection valve 42. When the connecting hole 423 of the redirection valve 42 is aligned and in communications with the forward air intake passage 23, the air entering the air intake passage 141 of the handle 14 is guided into the forward air intake passage 23, thereby driving the motor in the motor shell 21 to rotate forward. The air after driving the motor to rotate forward continues to go along the reverse air intake passage 24 to enter the through holes 426 of the redirection valve 42 and the exhaust hole 424. The air is then released after passing through in sequence the exhaust passage 142 and the exhaust hole 144 of the handle 14. On the other hand, as shown in FIG. 7, if the user pushes the pushing bar 43 of the redirection switch 41 in the other direction so that the connecting hole 423 of the redirection valve 42 is aligned and in communications with the reverse air intake passage 24, the air entering the air intake passage 141 of the handle 14 is guided into the reverse air intake passage 24, thereby driving the motor in the motor shell 21 to rotate in reverse. In this case, the air after driving the motor to rotate in reverse continues to enter the through hole 427 and the exhaust hole 425 of the redirection valve 42 via the forward air intake passage 23. The air is then released after passing through in sequence the exhaust passage 142 and the exhaust hole 144 of the handle 14.

According to the invention, the redirection switch 41 is disposed at the bottom of the motor shell 21. The pushing bar 43 of the redirection switch 41 and the redirection valve are connected in tandem along a horizontal line. The extension direction of the rotational axis of the redirection valve 42 is perpendicular to the penetrating axis of the on/off bar set 31. Therefore, the disclosed redirection valve 42 is not mounted on the on/off bar set 31. This makes the assembly much simpler.

In particular, the pushing bar 43 of the redirection switch 41 and the redirection valve are connected in tandem along a horizontal line. When the pushing bar 43 pushes the redirection valve 42 to rotate, the connecting hole 423 of the redirection valve 42 is accurately and smoothly connected with either the forward air intake passage 23 or the reverse air intake passage 24.

Besides, the redirection valve 42 of the disclosed redirection switch 41 is disposed in the accommodating recess 22 at the bottom of the motor shell 21, instead of the front end at the top of the handle 14. Therefore, the installation position of the pushing bar 43 is shifted backward. In this manner, the position of the pushing bar 43 is not too close to the front, more convenient for the user to operate.

Furthermore, the redirection valve 42 of the disclosed redirection switch 41 is disposed in the accommodating recess 22 at the bottom of the motor shell 21. This reduces the influence on the cross sections of the air intake and exhaust passages 141, 142 inside the handle 14. This ensures the output torque of the impact wrench.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. An impact wrench with an improved redirection switch, comprising:
a housing having an accommodating space inside and a handle with an air intake passage;
a motor shell disposed in the accommodating space of the housing and having an accommodating recess at the bottom thereof, one side of the inner wall of the accommodating recess having a forward air intake passage and a reverse air intake passage, and the bottom of the motor shell having a switch recess in communications with the other side of the inner wall of the accommodating recess and across both sides of the motor shell;
an on/off bar set disposed under the motor shell for controlling the air in the air intake passage of the handle to enter the motor shell via the accommodating recess; and
a redirection switch having a redirection valve disposed in the accommodating recess of the motor shell and a pushing bar through the switching recess of the motor shell and exposed from both opposite sides of the housing, the pushing bar and the redirection valve being connected in tandem along a horizontal line, wherein the end surface of the pushing bar connecting to the redirection valve has a continuous row tooth part and the end surface of the redirection valve connoting to the pushing bar has a snap tooth part matching with the row tooth part of the pushing bar;
wherein shifting the pushing bar drives the redirection valve to rotate inside the accommodating recess; the extension direction of the rotational axis of the redirection valve is perpendicular to the penetrating axis of the on/off bar set; the redirection valve has an air intake hole at a position corresponding to the air intake passage of the handle; the end surface of the redirection valve other than that connected with the pushing bar has a connecting hole in communications with the air intake hole; as the pushing bar rotates the redirection valve, the connecting hole is in communications with either the forward air intake passage or the reverse air intake passage; both sides of the connecting hole are formed with a through hole, respectively; two exhaust holes are formed by the air intake hole of the redirection valve to be in communications with an air exhaust passage of the handle; the two exhaust holes extend through the through holes on both sides of the connecting hole; when the connecting hole of the redirection valve is in communications with the forward air intake passage, the through hole of one exhaust hole is in communications with the reverse air intake passage; and when the connecting hole of the redirection valve is in communications with the reverse air intake passage, the through hole of the other exhaust hole is in communications with the forward air intake passage.

2. The impact wrench with an improved redirection switch of claim 1, wherein the on/off bar set includes an action bar in a fixing base disposed at the bottom of the motor shell and having an opening opposite to the accommodating recess; the end of the action bar toward the exterior of the handle is connected with a trigger; and pressing the trigger moves the action bar to allow or disallow the air in the air intake passage of the handle to enter the motor shell via the opening.
